(19) United States
(12) Patent Application Publication
(10) Pub. No.: US 2018/0015879 A1
(43) Pub. Date: Jan. 18, 2018

(54) SIDE-VIEW MIRROR CAMERA SYSTEM FOR VEHICLE

(71) Applicant: MMPC Inc, Daejeon (KR)

(72) Inventor: Sung-Sil KIM, Seoul (KR)

(73) Assignee: MMPC Inc, Daejeon (KR)

(21) Appl. No.: 15/648,084

(22) Filed: Jul. 12, 2017

(30) Foreign Application Priority Data
Jul. 13, 2016 (KR) 10-2016-0088335

(51) Int. Cl. B60R 1/00; B60Q 1/52; G08G 1/017; B60Q 9/00; B60R 11/04

(52) U.S. Cl. CPC B60R 1/00; B60Q 9/008; B60R 11/04; G08G 1/0175; B60Q 1/525; B60R 2300/105; B60R 2300/308; B60R 2300/602; B60R 2300/303

(57) ABSTRACT

Disclosed is a side-view mirror system for a vehicle using a camera sensor. A side-view mirror camera system for a vehicle of the present invention includes: a camera sensor (1) on both side-view mirrors to obtain a rear image, and generating an analog signal and then converting the analog signal into a digital signal; a serialization device in the camera sensor (1) serializing the digital signal of the camera sensor (1) to transmit by a single signal line; a parallelization device inside the vehicle parallelizing the serial digital signal; an image signal processor (2) inside the vehicle performing image processing of the parallel digital signal to form a camera image; and a display device (6) displaying camera image information. Thus, it is possible to display captured images with minimal delay on the display device and to transmit image data to the inside of the vehicle by the single signal line.

### CROSS REFERENCE TO RELATED APPLICATION

The present application claims priority to Korean Patent Application No. 10-2016-0088335, filed July 13, 2016, the entire contents of which is incorporated herein for all purposes by this reference.

### BACKGROUND OF THE INVENTION

### Field of the Invention

The present invention relates to a side-view mirror system for a vehicle using a camera sensor.

### Description of the Related Art

As shown in FIG. 1, a side-view mirror for a vehicle according to the prior art is attached to a front pillar on the outside of the vehicle, so a driver may ascertain the running state of other vehicles behind through side-view mirrors while driving, and may change lanes in consideration of the running state of vehicles in adjacent lanes. Further, through use of side-view mirrors, the driver may park the vehicle by determining the distance from other parked vehicles, the existence of a facility, and pedestrians.

However, since the side-view mirror according to the prior art is installed at a considerable angle with respect to the front of the vehicle, when the driver looking ahead while driving wants to see the side-view mirrors, the driver cannot look ahead for a short time, and thus there is risk of an accident. In particular, in the case of a novice driver, it is very dangerous because the driver has to turn his/her head sideways for a considerable period of time to see the side-view mirrors to ascertain the state of the vehicles in adjacent lanes.

In an effort to solve the problems of the prior art, another prior art (Korean Patent Application Publication No. 10-2009-0094547, published on Sep. 8, 2009) is disclosed, in which a side-view mirror with a small-sized camera attached thereto as shown in FIG. 2 is attached to an outer front pillar of a vehicle. As shown in the configuration of FIG. 3, a camera sensor in the small-sized camera 310 (which incorporates the camera sensor and an image processing unit) attached to the side-view mirror generates an analog signal according to the exposure level of light sensed by each pixel and then converts the analog signal into a digital signal, whereafter the image processing unit 320 in the small-sized camera 310 performs image processing of the digital signal to form camera image data, and then transmits the camera image data to an electronic control unit 330 installed inside the vehicle.

Further, the electronic control unit 330 controls a display unit 340, a camera on/off switch 350, a camera horizontal-adjustment switch 360, and a camera vertical-adjustment switch 370, and provides the camera image data to the display unit 340 such that a captured image is displayed on a LED display device. Further, a speaker 380 provides road surface condition information and safe speed guidance by voice.

However, in the prior art shown in FIG. 3, since the camera image data is formed by image processing in the small-sized camera 310 attached to the side-view mirror, and generally the small-sized camera 310 uses the low-performance image processing unit 320, several hundreds of milliseconds are required for such image processing in the small-sized camera 310. Thus, since the image displayed on the LED display device was actually captured several hundred milliseconds earlier, in the case of a vehicle traveling at a high speed, due to the delay, an object may have an error of being 10-20 m from an actual position, thereby causing driver judgment error.

Moreover, since the camera image data formed in the small-sized camera 310 is large in size, it must be transmitted to the electronic control unit 330 at a high speed by a thick parallel data transmission line having a plurality of strands, which results in deterioration of image quality due to the high noise level by the high speed transmission, and wiring difficulty due to the thick transmission line.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention proposes a side-view mirror camera system for a vehicle, in which images captured by side-view mirrors with camera sensors are displayed with minimal delay on a display device, and image data is transmitted to an inside of the vehicle by a single signal line.

In order to achieve the above object, according to one aspect of the present invention, there is provided a side-view mirror camera system for a vehicle, the system including: a camera sensor provided on each of left and right side-view mirrors of the vehicle to obtain a rear image, and generating an analog signal according to an exposure level of light sensed by each pixel and then converting the analog signal into a digital signal; a serialization device provided in the camera sensor, and serializing the digital signal of the camera sensor and then transmitting a serial digital signal by a single signal line; a parallelization device provided inside the vehicle, and parallelizing the serial digital signal transmitted from the serialization device by the single signal line; an image signal processor provided inside the vehicle, and performing image processing of a parallel digital signal output from the parallelization device to form a camera image; and a display device displaying the camera image from the image signal processor.

According to the present invention with the above-described configuration, the images captured by the side-view mirrors with the camera sensors can be displayed with minimal delay on the display device, and the image data can be transmitted to the inside of the vehicle by the single signal line.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a conventional side-view mirror for a vehicle in the prior art;

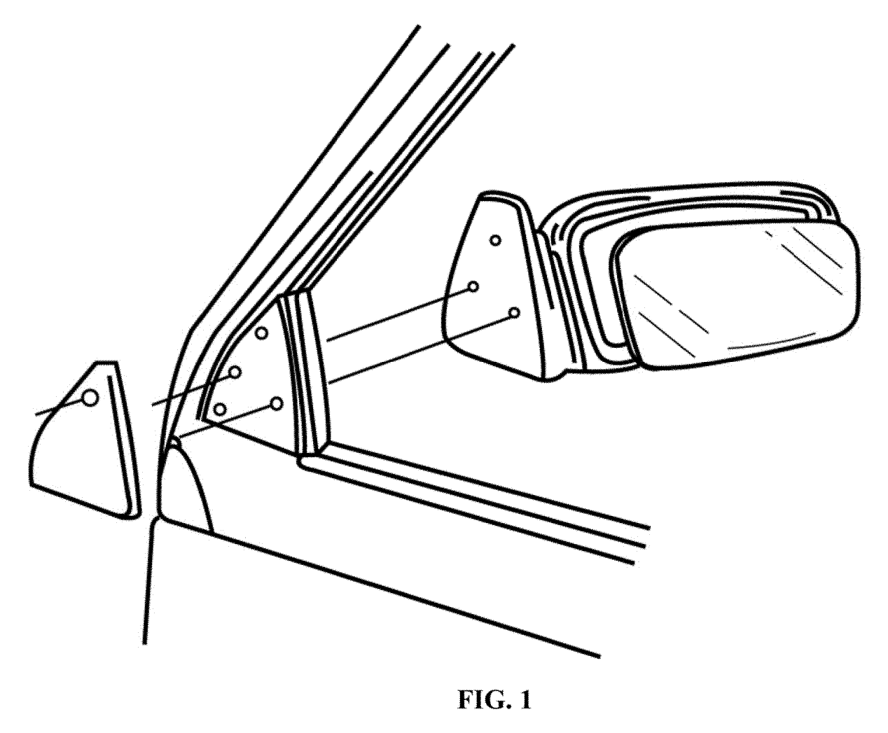

FIG. 2 is view showing an exterior of a side-view mirror with a camera in another prior art;

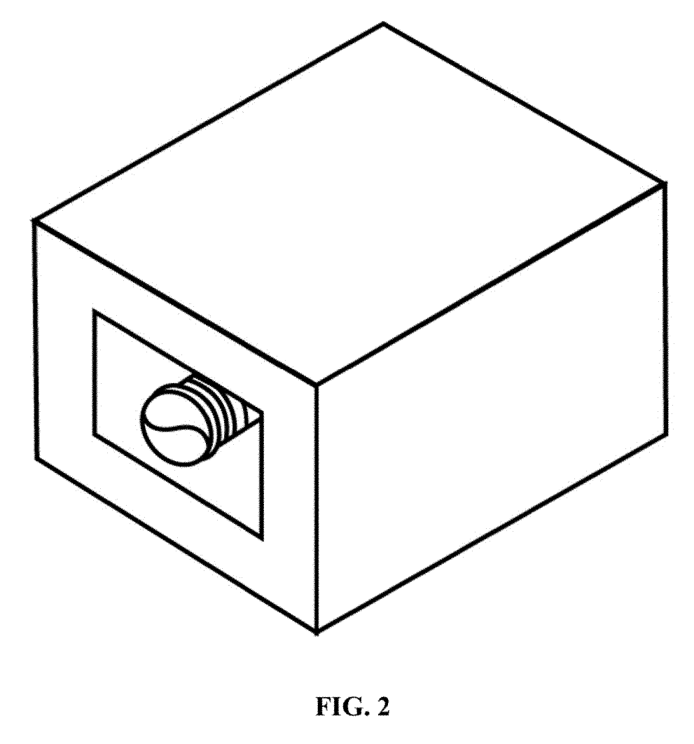

FIG. 3 is a view showing an overall configuration of the side-view mirror with the camera of FIG. 2;

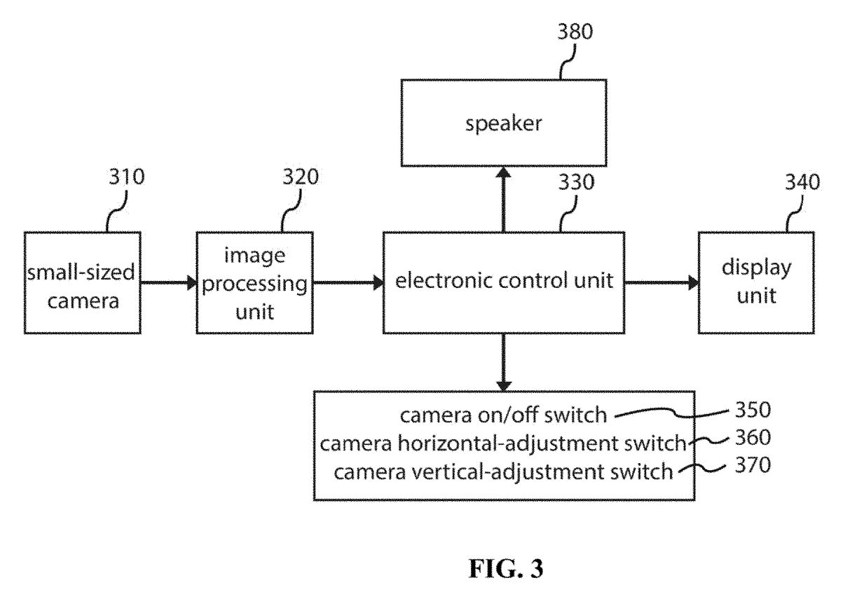

FIG. 4 is a view showing a camera sensor of the present invention attached on a side-view mirror, and a HUD screen;

FIG. 5 is a view showing an overall configuration of a side-view mirror camera system for a vehicle according to the present invention;

FIG. 6 is an enlarged view showing the HUD screen in which an image received from the camera sensor of the present invention is displayed; and

FIG. 7 is a view showing performance difference according to illuminance between an ultra low-light camera sensor used as the camera sensor in the present invention and a general camera sensor, and showing an image according to headlight compensation.

### DETAILED DESCRIPTION OF THE INVENTION

Hereinbelow, a side-view mirror camera system for a vehicle to which the present invention is applied will be described with reference to the accompanying drawings.

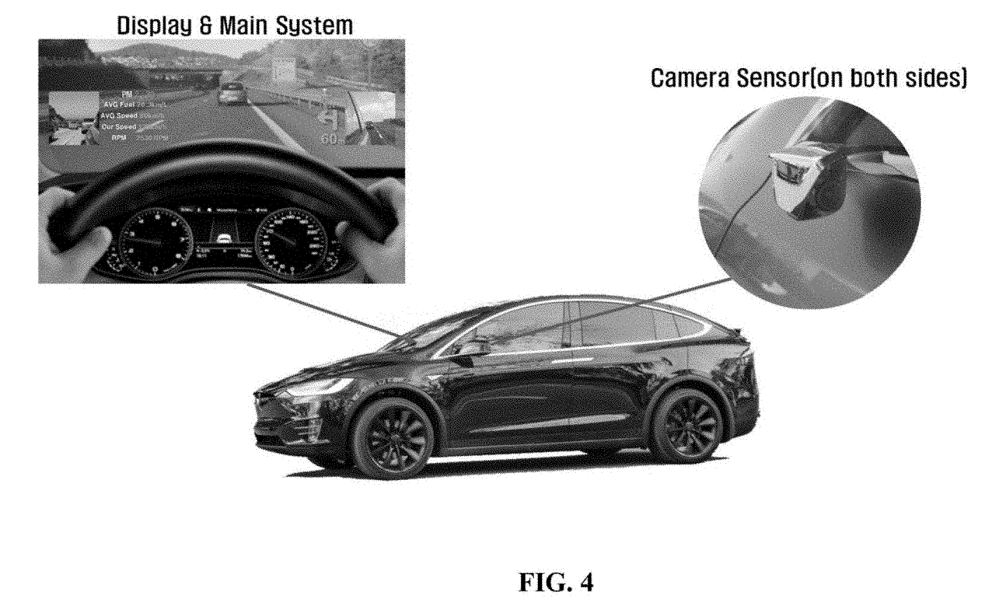

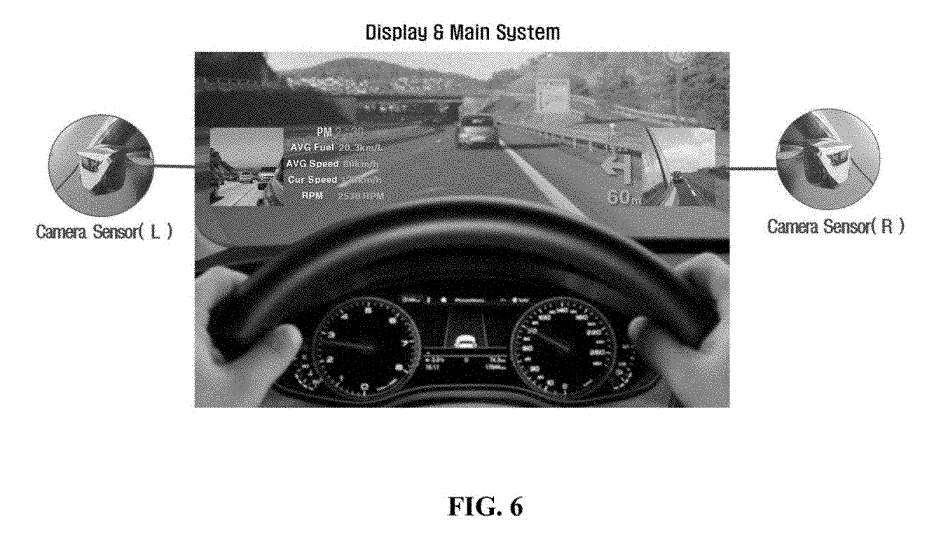

A side-view mirror with a camera sensor of the present invention is attached to a front pillar of a vehicle as shown in the right side of FIG. 4, and images of both neighboring lanes captured by side-view mirrors with the camera sensors are transmitted to a display device installed behind the instrument panel in the dashboard. Then, as shown in FIGS. 4 and 6, the display device displays the images of left and right side-view mirrors with camera sensors and various information (current time information, average speed information, average mileage information, remaining distance information, arrival time information, navigation route information are shown in FIG. 4) as a graphic image on a head-up display (HUD) panel (polarizing film attached to the panel transmits about 70% of an image, which results in a weak image on the polarizing film) attached to a window in front of a driver, thereby minimizing unnecessary shifting of the driver's gaze.

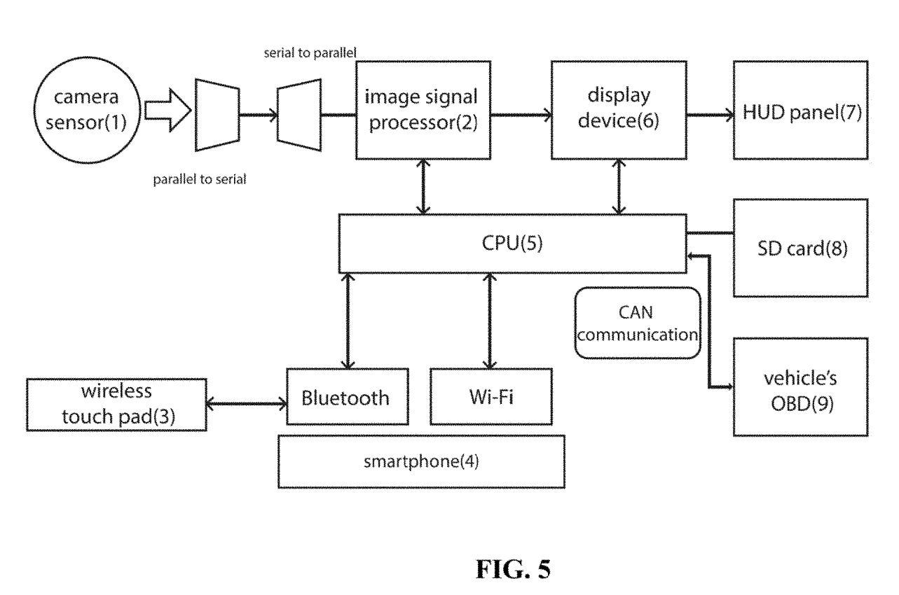

FIG. 5 shows that an overall configuration of a side-view mirror camera system for a vehicle according to the present invention.

A camera sensor 1 (which generates an analog signal according to the exposure level of light sensed by each pixel and converts the analog signal into a digital signal) installed at each of left and right sides of the vehicle captures an image of an adjacent lane in the rear area of the vehicle and forms small-size raw data.

Then, in order to transmit such small-size raw data to the inside of the vehicle by a single signal line, the camera sensor 1 converts the raw data image signal from parallel to serial and transmits a converted raw data image signal to an image signal processor (ISP) 2 by one signal line, whereafter the image signal processor 2 converts the converted raw data image signal from serial to parallel again.

Further, the image signal processor 2 (which is installed inside the vehicle and generally has high performance) performs image processing through the raw data image signal received from the camera sensor 1 to form a camera image at a high speed.

As a result, in the present invention, since the camera sensor 1 installed on an outside of the vehicle forms small-size raw image data without performing image processing, the raw image data can be transmitted to the inside of the vehicle by a serial single signal line at a low speed, and thus the camera image is formed by the high-performance image signal processor 2 installed inside the vehicle.

Thus, compared to the prior art where a camera is installed on the outside of the vehicle and image processing is performed by a low-performance image signal processor in the camera to transfer an image data to the inside of the vehicle, the time required for image processing is significantly reduced (in the time scale of tens of msec) and thus the delay time for displaying an image on the display device 6 (for example, LED display device) is significantly reduced, thereby solving the problem of a large-scale actual position error occurring in the prior art. In addition, the image data can be transmitted to the inside of the vehicle at low speed by the single signal line, thereby eliminating noise and achieving wiring convenience.

In addition, the image signal processor 2 performs an auto white balance function and an auto exposure function to enable the color temperature and the exposure level to be automatically adjusted, thereby forming an optimal image.

Further, the image signal processor 2 performs a motion detection function. When a motion of a considerable size is detected in the image received from the camera sensor 1, for example, when a pedestrian or an obstacle appears, or when a vehicle suddenly appears on the side, or when the driver vehicle leaves a lane, etc., the image signal processor 2 generates a danger detection alarm (a voice alarm or a video alarm) to alert the driver while driving.

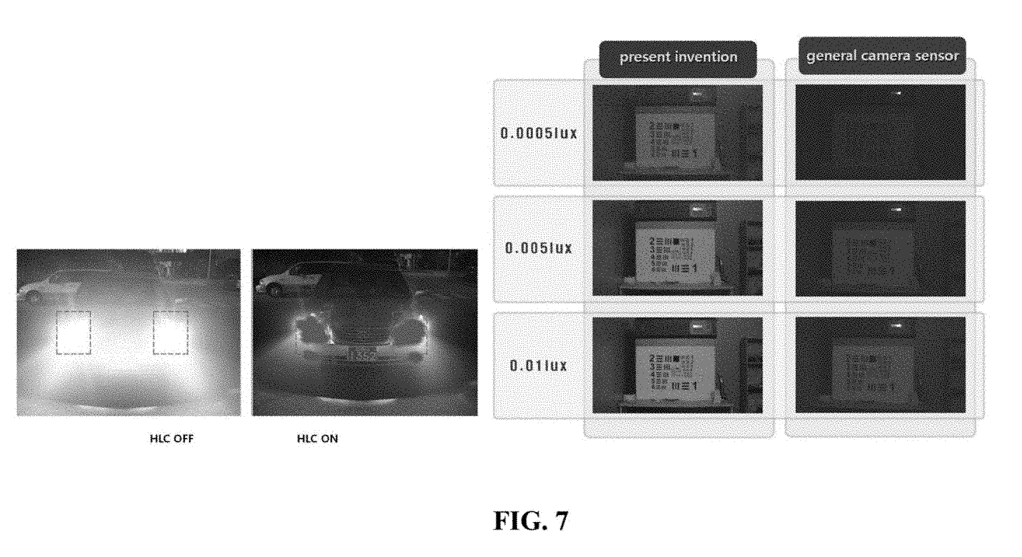

Further, when a headlight part of the image of the other vehicle appears too bright due to use of headlights at night, it is difficult to clearly see the other vehicle. Thus, the image signal processor 2 performs headlight compensation to ensure improved vehicle visibility to the driver (see the left side of FIG. 7).

Moreover, as shown in a comparison image on the right side of FIG. 7, the camera sensor 1 of the present invention may use an ultra low-light camera sensor to provide a clear image especially at night.

Thus, the image signal processor 2 processes the image from the camera sensor 1 through headlight compensation such that the headlight part is darkened and the overall brightness is increased, and thus the other vehicle can be seen clearly. Further, the ultra-low light camera sensor is used, thereby providing excellent vehicle recognition especially at night as compared to a general camera sensor.

A smartphone 4 performs a navigation function such that when the smartphone 4 transmits a navigation image to a CPU 5 by using a Bluetooth or Wi-Fi function, the CPU 5 allows the display device 6 to display the side-view mirror images and the navigation image on the HUD panel shown in FIG. 6 by using the side-view mirror images of the camera sensor 1 from the image signal processor 2 and the navigation image from the smartphone 4.

Further, a vehicle's on-board diagnostic (OBD) device 9 monitors systems related to exhaust gas and evaporative gas. When a failure occurs in the systems, fault details are stored in an ECU of the vehicle. It is also possible to read necessary information from OBD information from the ECU of the vehicle through a standard interface method (CAN communication) and display the information on a HUD screen.

Thus, as shown in FIG. 6, various information (navigation images and various data) as well as the images captured by the side-view mirrors with camera sensors are displayed on a windshield of the vehicle, so the driver can drive conveniently while viewing these images or data displayed on the windshield.

Meanwhile, the smartphone 4 controls data transmission/reception between the image signal processor 2 and the display device 6 via the CPU 5, controls storage of image data in a SD card 8, controls data reception in the vehicle OBD device 9, and controls up, down, left, and right directions of the camera sensor 1, if necessary.

A wireless touch pad 3 is used when the smartphone 4 is not in use, and performs various controls instead of the smartphone 4 by connecting to the CPU 5 by using the Bluetooth function.

Further, the left and right side-view mirror images in the image signal processor 2 are compressed via the CPU 5 and then stored in the SD card 8, such that the stored left and right side-view mirror images are used to identify a cause of an accident afterward.

As a result, according to the present invention, the images captured by the side-view mirrors with the camera sensors are stored in the memory card, so a user can identify the cause of the accident by playing the stored images afterward. In addition, a user can conveniently adjust the side-view mirrors with the camera sensors by using the smartphone or the wireless touch pad and can control various information display and storage of captured images in the memory card.

Next, the additional functions described above will be briefly described.

First, an auto white balance will be described.

There is a difference in the expression of color depending on light during the capturing of images. When the color temperature is low, more red light exists, and when the color temperature is high, more blue light exists. Accordingly, the color of a subject is red in incandescent light, is blue in fluorescent light, and is expressed differently depending on the temperature of light (color temperature) even under the same sunlight such as daylight or sunset. In order to prevent this, the white balance function corrects the color temperature of light through the system software installed in the camera, the lighting condition, or the image equipment to produce an ideal white balance. An example of an auto white balance method is disclosed in Korean Patent Application Publication No. 10-2005-0015479 (published on Feb. 21, 2005).

Next, an auto exposure control will be briefly described.

An auto exposure device in the camera automatically adjusts the exposure. The camera has an auto exposure function that automatically controls the amount of light reaching a film and the exposure time by adjusting an opening ratio of an aperture and a shutter speed in consideration of the light quantity of the environment and the light reflectance of the subject. An example of an auto exposure control method is disclosed in Korean Patent Application Publication No. 10-2003-0027440 (published on Apr. 7, 2003).

Now, the motion detection function will be described.

The motion detection function is a function that compares a received current frame image with a next frame image, and judges that there is a motion if there is a change. In the present invention, when another object (obstacle, person, etc.) approaches or the driver's vehicle leaves the lane, a warning alarm is provided through the motion detection function. An example of a motion detection method is disclosed in Korean Patent Application Publication No. 10-2012-0119901 (published on Oct. 31, 2012).

Next, a headlight compensation function will be described.

When light from vehicle's headlights is strong, whitening occurs on the camera image, so the headlight compensation function improves the camera image dazzled by strong light to allow the driver to recognize oncoming vehicles. As shown in the left side of FIG. 7, the headlight compensation function of the present invention is performed by processing the image such that a bright region is determined to be the headlight part and then is processed to appear dark, and a remaining region is increased in brightness.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A side-view mirror camera system for a vehicle, the system comprising:
a camera sensor (1) provided on each of left and right side-view mirrors of the vehicle to obtain a rear image, and generating an analog signal according to an exposure level of light sensed by each pixel and then converting the analog signal into a digital signal;
a serialization device provided in the camera sensor (1), and serializing the digital signal of the camera sensor (1) and then transmitting a serial digital signal by a single signal line;
a parallelization device provided inside the vehicle, and parallelizing the serial digital signal transmitted from the serialization device by the single signal line;
an image signal processor (2) provided inside the vehicle, and performing image processing of a parallel digital signal output from the parallelization device to form a camera image; and
a display device (6) displaying the camera image from the image signal processor (2).

2. The system of claim 1, further comprising:
a head-up display (HUD) panel (7) attached to a windshield at a location in front of a driver's seat, and displaying the camera image of the display device (6) on the windshield in front of the driver's seat.

3. The system of claim 2, wherein both the display device (6) and the HUD panel (7) further display navigation information from a smartphone (4).

4. The system of claim 1, wherein the image processing performed by the image signal processor (2) further includes at least one of an auto white balance function, an auto exposure function, a headlight compensation function, and a motion detection function.

5. The system of claim 2, wherein both the display device (6) and the HUD panel (7) further display information from a vehicle's on-board diagnostic (OBD) device (9).

6. The system of claim 1, wherein the camera sensor (1) is an ultra low-light camera sensor.

7. The system of claim 3, wherein the smartphone (4) transmits the navigation information to the display device (6) via Bluetooth or Wi-Fi.

8. The system of claim 3, further comprising:
a wireless touch pad (3) performing various controls through Bluetooth communication when the smartphone (4) is not in use.
